(19) United States
(12) Patent Application Publication
(10) Pub. No.: US 2003/0001090 A1
(43) Pub. Date: Jan. 2, 2003

(54) Ultra-high throughput system and method for analyzing samples

(76) Inventors: Yasmin Ranasinghe, Chapel Hill, NC (US); Robyn Noonan, Durham, NC (US); Stephanie Padilla, Morrisville, NC (US); Christopher Beecher, Chapel Hill, NC (US)

Correspondence Address: PARADIGM GENETICS, INC, 108 ALEXANDER DRIVE, P O BOX 14528, RTP, NC, 27709-4528, US

(21) Appl. No.: 09/865,068

(22) Filed: May 24, 2001

(51) Int. Cl. H01J 49/04

(52) U.S. Cl. 250/288; 250/282; 250/287

(57) ABSTRACT

A high-throughput system and a method for analyzing up to hundreds of components in an sample, such as from an organism, tissue or extract is described.

### FIELD OF THE INVENTION

The invention relates generally to a system and a method capable of analyzing up to hundreds of components in a sample, such as from an organism, tissue or extract.

### BACKGROUND OF THE INVENTION

Gene sequence information, although critical to understanding biological phenomena, is insufficient by itself. A functional genomics approach, which provides a broader cellular perspective, is a necessary foundation for more advanced genomic and pharmaceutical research. The challenge is to find effective methods to reveal the function of the newly discovered genes. Gene function is closely related to, but is certainly not limited to, biochemical phenomena such as metabolic activity, gene expression and proteomics.

All organisms utilize a multitude of small molecules as biochemical intermediates and end-points that are often present at trace levels. We have focused on the ever-increasing demand for high-throughput biology to screen effectively and unambiguously a large number of samples to determine and differentiate a wild-type baseline metabolic profile from stress related behavior. Mass spectrometry is one of the most sensitive techniques that can be utilized for unambiguous identification of molecules at extremely low concentrations.

To date there do not appear to be any publications describing an analytical method that can screen up to hundreds of compounds in a short period of time, i.e. less than about 30 minutes. It would be desirable to provide a system, apparatus or method that can analyze for many samples in a short period of time in order to allow high-throughput analyses.

### SUMMARY OF THE INVENTION

Surprisingly, the present inventors have discovered and developed an ultra-fast high throughput, first pass/fail screening method to analyze for metabolites in sample tissues or extracts from organisms with minimal sample preparation. Normally, analysis of a complex mixture ‘cocktail’ can easily generate hundreds and thousands of unidentified peaks to overwhelm analysts involved in metabolic pathway identification. Our strategy to overcome this problem was to perform ultra-fast screening and pattern recognition to pass/fail samples by first separating compounds by liquid chromatography and then identifying using mass spectrometry.

In one embodiment, the present invention is directed toward a system or apparatus for analyzing compounds in a liquid sample, comprising:

a) means for separating the compounds in said liquid sample;

b) means for dividing said separated compounds into equal first and second portions;

c) means for ionizing compounds in said first portion;

d) means for ionizing compounds in said second portion;

e) means for detecting and forming electronic signals corresponding to the positively charged ions in said first portion;

f) means for detecting and forming electronic signals corresponding to the negatively charged ions in said second portion;

g) means for combining signals from said first and second detecting means into data for both the positively and negatively charged ions; and

h) means for displaying the data for said positively and negatively charged ions.

The means for separating said compounds in said liquid phase can be a liquid chromatography column. The means for splitting said separated compounds can be a Y-shaped connector between said a) separating means and said c) and d) ionizing means.

The ionizing means can be an ion spray source. The means for detecting and forming electronic signals corresponding to the positively charged ions in the first portion or the negatively charged ions in the second portion can be a Time-of-Flight (TOF) mass spectrometer. The means for combining the signals corresponding to said first and second detecting means into data can be software that combines the data or processed information concerning the compounds into a database.

The means for displaying the data for said positively and negatively charged ions can a chromatogram, graph, chart, table or combinations thereof.

In a second embodiment, the present invention is directed towards a method for analyzing compounds in a liquid sample, comprising:

a) separating the compounds in said liquid sample;

b) dividing said separated compounds into equal first and second portions;

c) ionizing compounds in said first portion;

d) ionizing compounds in said second portion;

e) detecting and forming electronic signals corresponding to the positively charged ions in said first portion;

f) detecting and forming electronic signals corresponding to the negatively charged ions in said second portion;

g) combining signals from said first and second detecting means into data for both the positively and negatively charged ions; and

h) displaying the data for said positively and negatively charged ions.

One advantage of the present invention is that it provides a system and method for analyzing samples that can be applied to all types of sample extracts including plant, microbial and animal tissues.

A second advantage of the present invention is that it provides a system and method for analyzing samples in which molecular weight information and/or definitive compound identification can be obtained, since fragmentation of the ions is not observed.

A third advantage of the present invention is that it provides a system and method for analyzing samples in which it may not be necessary to derivatize or modify the molecules during sample preparation so that the sample can be analyzed in its natural state, compared to other methods that utilize derivatization techniques that chemically modify the molecule.

A fourth advantage of the present invention is that it provides a system and a method for analyzing samples that provides high mass resolution and mass accuracy to give quality data.

A fifth advantage of the present invention is that it provides a system and method for analyzing samples that enables many samples to be analyzed in high throughput operations due to ultra fast mass scanning and shortened times for sample runs.

A sixth advantage of the present invention is that it provides a system and method for analyzing samples that can be quantitated using isotopically labeled compounds.

A seventh advantage of the present invention is that it provides a system and method for analyzing samples that is amenable to cataloguing mass spectral libraries for future reference.

An eighth advantage of the present invention is that it provides a system and method for analyzing tens and even hundreds of components in a complex sample, and thus is well adapted for screening a complex mixture or sample containing many compounds.

### BRIEF DESCRIPTION OF THE DRAWINGS

FIG. 1 shows the design of the system for high-throughput sample analysis.

FIG. 2 shows the parts of the Mariner API-TOF Mass Spectrometer and operation

FIG. 3a shows a printout of a computer screen showing the parameters for the ionizing source generating positively charged ions.

FIG. 3b shows a printout of a computer screen showing the parameters for the ionizing source generating negatively charged ions.

FIG. 4a shows the total ion chromatogram (TIC) and ion chromatograms for individual compounds in a plant extract for positive ionization or positively charged ions.

FIG. 4b shows the total ion chromatogram (TIC) and ion chromatograms for individual compounds in a plant extract for negative ionization or negatively charged ions.

### DETAILED DESCRIPTION OF THE INVENTION

Mass spectrometers have been successful in solving problems in biochemistry, immunology, genetics and in many other fields of biology. The remarkable success is primarily due to atmospheric pressure ionization, which is a soft ionization technique that can create intact molecular adducts with no fragmentation. The Time-Of-Flight (TOF) mass spectrometer coupled to the turbo ion spray source provides the high resolution, mass accuracy and the fast scan speed that is needed for high-throughput screening of aqueous extracts with minimal sample preparation. TOF mass spectrometers provide the required selectivity, sensitivity, excellent mass accuracy, speed and quality data that could be catalogued with the mass spectral (MS) libraries for comparison with stress related spectra and data.

The sample to be analyzed can be obtained from any biological organism from any of the kingdoms, such as animalia, planta, protista, monera, fungi, and archae. For example, plants such as Arabidopsis thaliana can be used, including extracts of leaves, stems, roots, seeds or seed pods such as siliques. Where tissues from vertebrates such as mammals are being analyzed, samples can be taken from the tissues, the blood or other body fluids, such as urine.

The sample can be extracted from the tissue using any suitable solvent, such as a polar organic solvent or preferably, a polar organic solvent admixed or miscible with water. One suitable class of polar organic solvents includes the alcohol solvents containing a hydroxy (—OH) moiety. Suitable alcohol solvents include C1 to C6 alcohol solvents, such as methanol, ethanol, propanol, butanol, hexanol and the like. Preferably, after the sample has been extracted with the organic solvent, the sample extracts are not derivatized or subjected to an extensive cleanup procedures.

The sample is moved or carried through the system or apparatus for a time effective or sufficient to separate and analyze compounds extracted into the organic solvent. Such times can range from about 5 to about 30 minutes, preferably about 10 to 20 minutes, more preferably about 10 minutes.

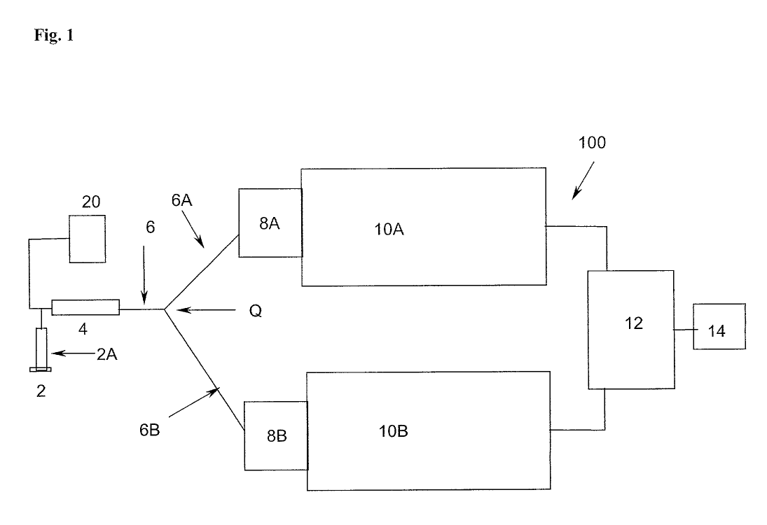

FIG. 1 shows the design of the system 100 for high-throughput sample analysis. System 100 is made up of source 20 that supplies a mobile phase (flow) or stream, liquid separating device 4, sample splitters 6, 6A and 6B, ionization sources 8A and 8B, mass spectrometer detectors 10A and 10B, system 12 for collating data and output 14 in the form of chromatograms, graphs, tables, charts and the like. A syringe or injector 2 containing a liquid or solvent-containing sample 2A to be analyzed is injected into liquid separating device 4. Optionally, one or more known compounds can be added to the sample to serve as an internal standard for quantitative or semi-quantitative measurements of other compounds in the sample. Source 20 for the mobile phase provides the liquid orgas that serves as the mobile phase that carries or transports sample 2A through system 100. Components or compounds in the liquid sample 2A are separated in liquid separating device 4, such as a high pressure liquid chromatography (HPLC) column, a capillary electrophoresis (CE) column or any other suitable device for separating the components in liquid sample 2A. As the components in liquid sample 2A are separated from each other in device 4, they enter stream splitter 6 and are split at junction Q into stream splitting arms 6A and 6B. Stream splitters 6, 6A and 6B can be of any suitable design or construction (such as “Y” or “T” shaped) that divides or splits the components from liquid sample 2A into two substantially equal streams or flows. Preferably, the conditions within stream splitters 6, 6A and 6B are sufficiently balanced so that the flow in splitter arm 6A is kept in registry with the flow in splitter arm 6B. Accordingly, about one-half (½) of the components from liquid sample 2a flow into splitting arm 6A while the remaining one-half of the components flow into splitting arm 6B. Components in splitting arm 6A are ionized as a spray in ionizing source 8A that generates positive ionization or positively charged ions and components in splitting arm 6B are also ionized as a spray in ionizing source 8B that generates negative ionization or negatively charged ions. The turbo ion spray sources can be optimized to generate and monitor either positive or negative ions. The positively ionized components from source 8A generates a current or electronic signal that is detected by mass spectrometer or detector 10A designed to analyze or detect the positively (+) charged ions or components that have been ionized from sample 2A. Concurrently or at about the same time, the negatively ionized components from source 8B generates a current or electronic signal that is detected by mass spectrometer or detector 10B designed to analyze or detect negatively (−) charged ions or components that have been ionized from sample 2A. Thus, it is highly preferred that the ionized components in mass spectrometers 10A and 10B are in registry, i.e. the same components are passing synchronously or nearly so, into the lenses of each mass spectrometer, so that the components are in register with each other. The mass spectrometer can be of any suitable design or construction that can detect positively and negatively charged ions and includes spectrometers such as Time-of-Flight (TOF), Fourier transform (FT), sector, ion traps and quadrapole detectors. Software or computer algorithm 12 combines or collates signals from mass spectrometers 10A and 10B into a database that can be represented in any suitable form 14 for presentation or analysis such as a chromatogram, graph, chart, table or combinations thereof.

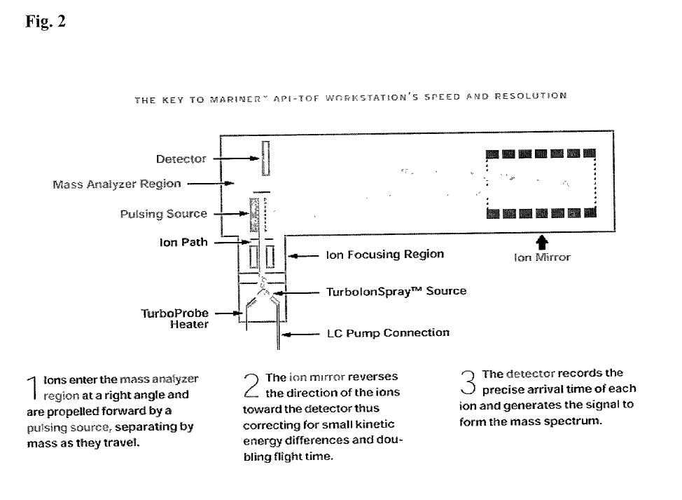

FIG. 2 shows the parts of the Mariner API-TOF Mass Spectrometer and operations, including the parts and steps 1, 2 and 3.

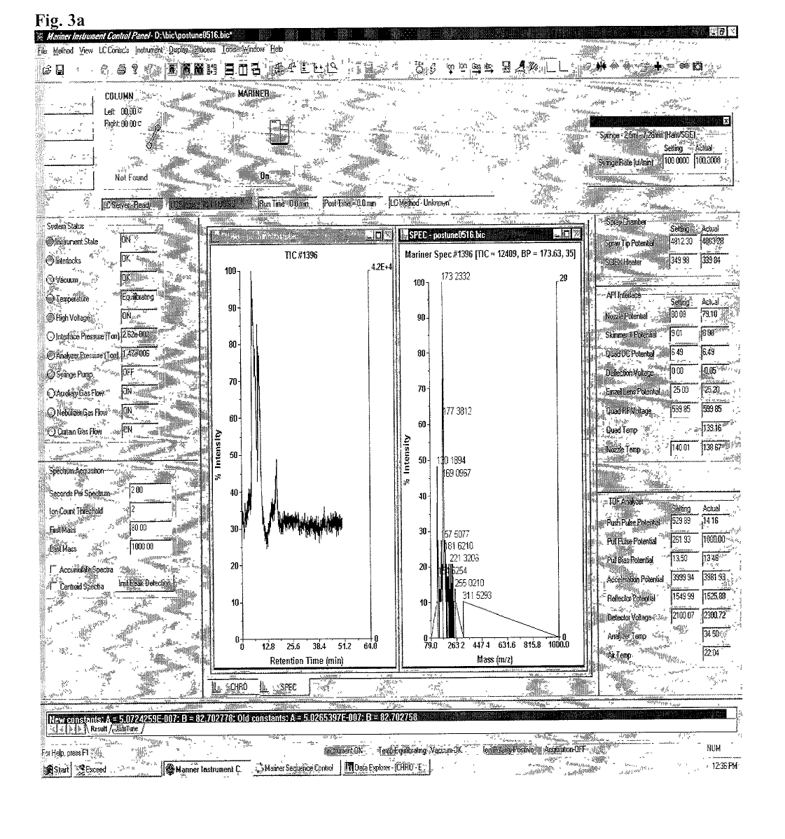

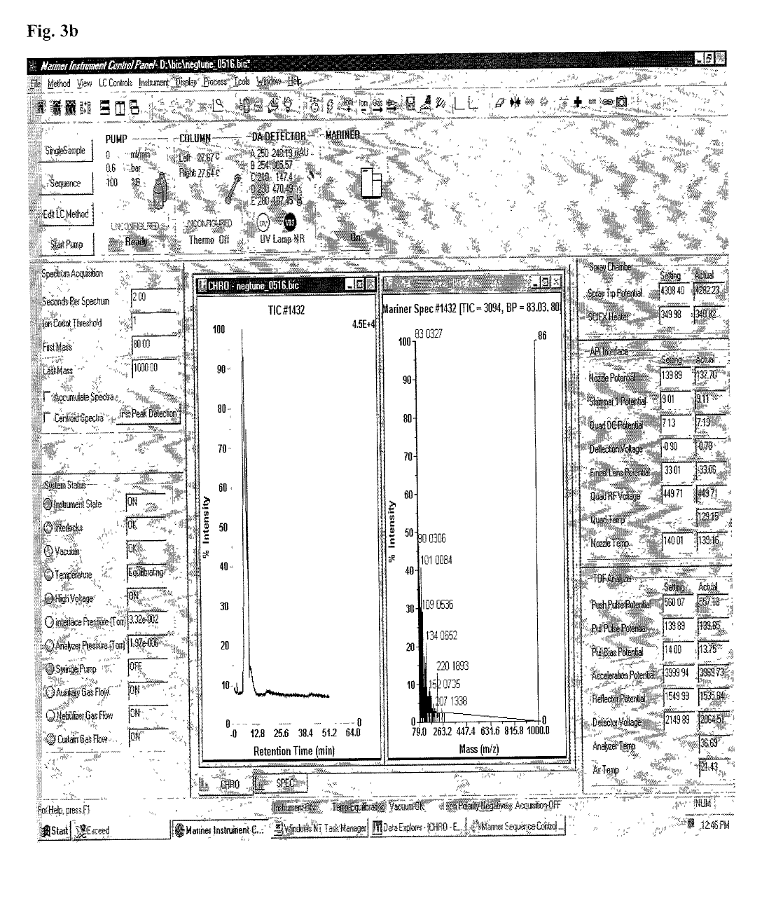

FIG. 3a shows a printout of a computer screen showing the parameters for the ionizing source generating positively charged ions.

FIG. 3b show a printout of a computer screen showing the parameters for the ionizing source generating negatively charged ions.

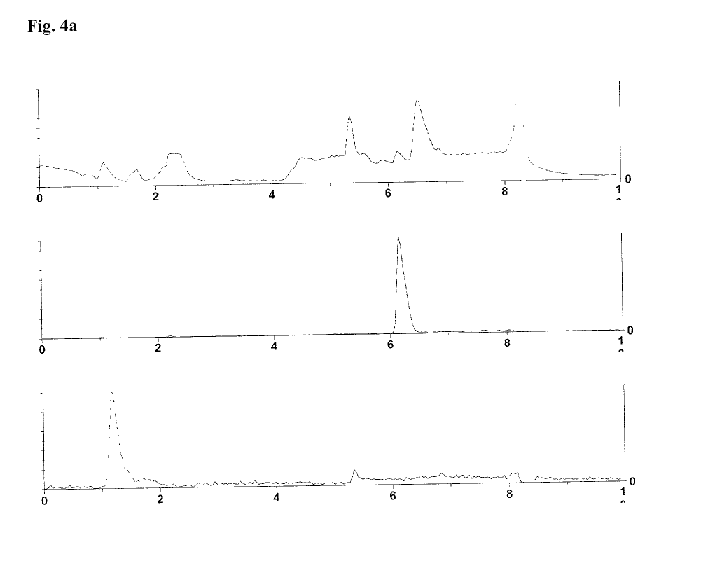

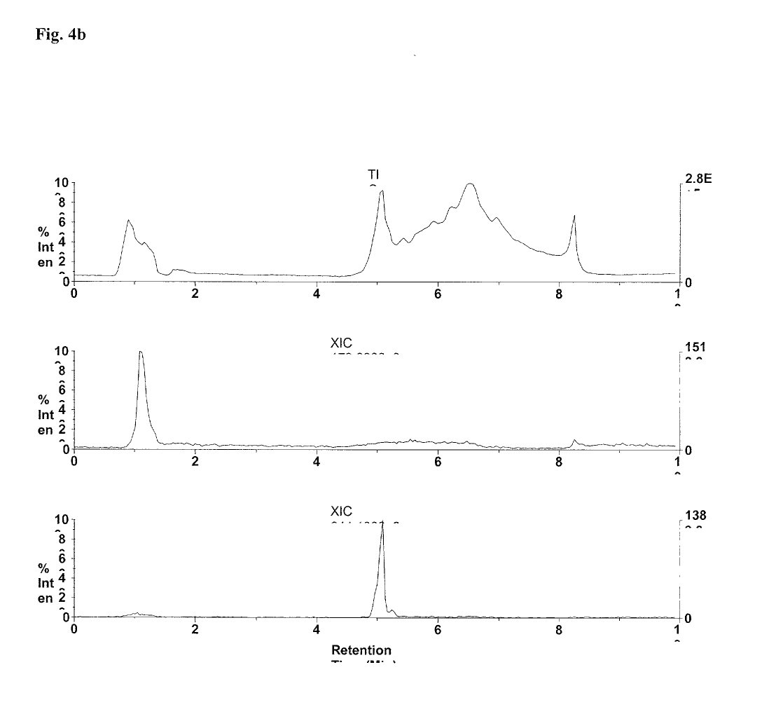

FIG. 4a shows the total ion chromatogram (TIC) and ion chromatograms for individual compounds in a plant extract for positive ionization or positively charged ions.

FIG. 4b shows the total ion chromatogram (TIC) of a liquid extract and chromatograms of individual compounds in the extract with mass/charge ratios (m/z) of 179.098 and 244.10 for negative ionization or negatively charged ions.

The following sections on Instrumentation, Analyses and Example are provided to show an example of the invention and the manner in which it may be practised, but is not intended to limit the overall scope of the claimed invention.

Instrumentation:

High Pressure Liquid Chromatography (HPLC):

An HP 100, HPLC system consists of a 96-well plate autosampler with a UV photodiode array detector. The compounds get separated at the column prior to infusion to the mass spectrometer.

Mass Spectrometry:

TOF instruments are designed to generate (ionize), transmit, separate and detect ions. The three major components are the source, the analyzer and the detector. Ionization occurs in the source then transmitted through the flight tube and finally detected at the micro channel plate detector.

Source—Turbo Ion Spray

Ionization makes it possible to do mass analysis and detection of atoms and molecules. We have utilized a turbo ion spray source, which is an atmospheric pressure ionization technique, to ionize metabolites present in both positive and negative mode, thus generating (M+H)⁺ and (M−H)⁻ ions. The gas introduced at high temperature facilitates desolvation and formation of small droplets. The negative ion source was modified in-house to optimize negative ion detection. Ion Source parameters for the positive and negative modes are given in FIGS. 3a and 3b.

Analyzer—TOF Tube

The ions generated are extracted and then accelerated to the analyzer region. The ions exit the source and enter the flight tube which is referred to as a “field free drift region” with the proper velocity and direction to arrive at the detector. Energy focusing and spatial focusing that occur prior to hitting the detector results in high resolution mass spectrometry. Ions are pulsed in to the flight tube in well-defined packets. The light ions travel faster than the heavier ions, thus separating in to defined individual packets by mass number (FIG. 2).

Detector—Micro Channel Plate (MCP)

The detector amplifies the ion packet by releasing a cascade of electrons with over one million electrons for each ion that hits. The signal is thus converted to a current, as each packet of ions became a mass peak. The flight time is related to the mass of an ion as follows.

t=(m/(2KE)^{1/2}D

t=flight time

m=mass of the ion

KE=kinetic energy

D=drift distance

n=number of charges in the ion

The mass spectrum is created because ions of different masses arrive at the detector at different times.

Data Analysis:

The Total Ion Chromatogram (TIC) of the metabolic profile was analyzed for metabolites with masses ranging from 80-900 Da. The individual ion traces of the extracted ion chromatogram of the (M−H)⁻ (negative) and (M+H)⁺ (positive) ions were used for both calibration and quantitation.

Relative amounts of the compounds were obtained by determining the intensity and peak areas of individual ion traces. Isotopically labeled internal standards were used for peak area ratios, response factor and normalization of data throughout the experiment. Linear calibration curves and internal standards were used for quantification of the endogenous levels of the metabolites in the crude plant extracts. Target quantification package was utilized to process the data prior to statistical analysis. A total of over 300 peaks were detected in both positive and negative mode in the wild-type samples. The total ion chromatogram (TIC) of a plant extract and the extracted ion chromatograms are shown for positive and negative ionization in FIGS. 4a and 4b.

The exact molecular weight was calculated using the assigned peaks. The mass spectrum profile is evaluated for isotopic distribution primarily due to C₁₃ contributions. The most likely elemental composition is then computed using nitrogen rule, isotopic ratio contributions and scanning molecular weight libraries. The most likely formula is then entered in the metabolic data base search forms. The compounds are then ranked according to most likely metabolic pathways. The highest-ranking compounds are purchased and analyzed by retention time and mass spectra for confirmation. Software that can be used as means for combining signals from said first and second detecting means into data or processed information concerning both the positively and negatively charged ions is available from commercial sources, such as Target Software by Thru-Put Systems Inc., Orlando, Fla., that can be used to automate data analysis from processing to review to reporting.

### EXAMPLE

Ten (10) mg of sample were weighed into a 96 well plate and extracted in 0.5 mL 10% MeOH fortified with isotopically labeled extraction standards (E.S.) and 0.5 mL of 50:50 mobile phase A: B. Some samples were pulverized and others were not pulverized. Pulverized samples were finely mixed using lithotripsy or sonoporation (‘Bustered’) for 30 seconds using a 20% duty cycle with the temperature threshold set at 30° C. The sample was then centrifuged for 2 min. at 4000 rpm. The supernatant was transferred to a new 96-well plate and centrifuged again for 2 min at 4000 rpm. 200 μL was then transferred to a 250 uL, 96-well plate autosampler. Ten (10) μL (10 μg/mL) of the internal standard (I.S.) was then added to each well. The sample tray was covered with a suitable mat to prevent evaporation and placed in a temperature-controlled (4° C.) 96-well plate autosampler. The flow passes through a reverse phase column, splits at a T-connector prior to infusion to ion spray sources of two separate Mariner TOF mass spectrometers. The Mariner™ Biospectrometry™ Workstation is a benchtop electrospray time-of-flight (ESI-TOF) mass spectrometer that allows acquisition of high-resolution time-of-flight spectra.

E. S./I. S. Mix: 4F Naphthoic, DBMP, D3 methionine, 4F Phenyl alanine, D5 Tryptophan, D2 Phenylalanine, D5 Benzoic, D3 Alanine, D3 Aspartic acid, D4 Citric acid, D4 Fumaric acid, D4 Lysine, D5 Phenyl alanine, DS Valine

Column: Restek Ultra aqueous C18, 5μ, 2.1×100 mm

Column Temperature: 30° C.

Autosampler Temperature: 4° C.

Mobile Phase A: 5 mM NH₄Ac in H₂O

Mobile Phase B: 5 mM NH₄Ac in ACN

Gradient:

TABLE I

| Time | % A | % B | Flow |
|---|---|---|---|
| 0.00 | 85 | 15 | 0.25 ml/min |
| 1.00 | 85 | 15 | 0.25 ml/min |
| 3.00 | 0 | 100 | 0.25 ml/min |
| 5.00 | 0 | 100 | 0.25 ml/min |
| 5.50 | 85 | 15 | 0.25 ml/min |
| 10.00 | 85 | 15 | 0.25 ml/min |

The column has the capacity to retain highly polar compounds such as amino acids and combined with the solvent gradient in Table I, separate and elute compounds present in the extract.

While the foregoing describes certain embodiments of the invention, it will be understood by those skilled in the art that variations and modifications may be made and still fall within the scope of the invention.

What is claimed is:

1. A system for analyzing compounds in a liquid sample, comprising:
a) means for separating the compounds in said liquid sample;
b) means for dividing said separated compounds into equal first and second portions;
c) means for ionizing compounds in said first portion;
d) means for ionizing compounds in said second portion;
e) means for detecting and forming electronic signals corresponding to the positively charged ions in said first portion;
f) means for detecting and forming electronic signals corresponding to the negatively charged ions in said second portion;
g) means for combining signals from said first and second detecting means into data for both the positively and negatively charged ions; and
h) means for displaying the data for said positively and negatively charged ions.

2. The method of claim 1 wherein the a) means for separating said compounds in said liquid phase is a liquid chromatography column.

3. The method of claim 1 wherein the b) means for splitting said separated compounds is a Y-shaped connector between said a) separating means and said c) and d) ionizing means.

4. The method of claim 1 wherein the c) ionizing means is an ion spray source.

5. The method of claim 1 wherein the d) ionizing means is an ion spray source.

6. The method of claim 1 wherein the e) means for detecting and forming electronic signals corresponding to the positively charged ions in said first portion is a Time-of-Flight (TOF) mass spectrometer.

7. The method of claim 1 wherein the f) means for detecting and forming electronic signals corresponding to the negatively charged ions in said second portion is a Time-of-Flight (TOF) mass spectrometer.

8. The method of claim 1 wherein the g) means for combining signals from said first and second detecting means into data for both the positively and negatively charged ions is software that combines the data or processed information concerning the compounds into a database.

9. The method of claim 1 wherein the f) means for displaying the data for said positively and negatively charged ions is a chromatogram, chromatograph, graph, chart, table or combinations thereof.

10. A method for analyzing compounds in a liquid sample, comprising:
a) separating the compounds in said liquid sample;
h) dividing said separated compounds into equal first and second portions;
i) ionizing compounds in said first portion;
j) ionizing compounds in said second portion;
k) detecting and forming electronic signals corresponding to the positively charged ions in said first portion;
l) detecting and forming electronic signals corresponding to the negatively charged ions in said second portion;
m) combining signals from said first and second detecting means into data for both the positively and negatively charged ions; and
n) displaying the data for said positively and negatively charged ions.
